(19) United States
(12) Patent Application Publication
(10) Pub. No.: US 2001/0049406 A1
(43) Pub. Date: Dec. 6, 2001

(54) Wood additive thermoset composite and a method for making the same

(76) Inventors: David H. Cox, Chatsworth, CA (US); Michael J. Elliott, La Verne, CA (US)

Correspondence Address: Squire, Sanders & Dempsey L.L.P., 14th Floor, 801 South Figueroa Street, Los Angeles, CA, 90017-5554, US

(21) Appl. No.: 09/834,017

(22) Filed: Apr. 12, 2001

Related U.S. Application Data
(60) Provisional application No. 60/196,890, filed on Apr. 13, 2000.

(51) Int. Cl. C08J 3/00; C08L 5/00

(52) U.S. Cl. 524/27

(57) ABSTRACT

The present invention provides a wood additive thermoset composite (WATC) to mold a three dimensional product, such as a speaker cabinet, which combines the favorable qualities of both wood and thermosetting resin/plastic. In particular, the WATC has at least about 50% wood by weight with the rest substantially being thermosetting resin material by weight.

### RELATED PATENT APPLICATION

This application claims priority from a provisional application having application Ser. No. 60/196,890 and filed on Apr. 13, 2000, which is hereby incorporated into this application by reference.

### BACKGROUND OF THE INVENTION

1. Field of the Invention

This invention relates generally to wood additives to thermoset composite material and, more particularly, wood additives in thermoset composites that are moldable into three-dimensional shapes having a high damping factor and stiffness.

2. General Background and State of the Art

Many electronic cabinets such as speaker cabinets are made of wood. One of the advantages of wood is that it damps well at high frequencies, as speakers (transducers) generally resonate at high frequencies. That is, a speaker cabinet made of wood does a good job of damping the high frequencies produced by the speakers to improve the quality of the sound. Unfortunately, wood cabinets tend to be heavy and expensive to manufacture. For example, to manufacture a cabinet having a base and side walls, i.e., a three-dimensional cabinet, the base and each side wall are manufactured separately then assembled together. For example, a ½-inch Medium Density Fiberboard (MDF) wood has a Q-damping factor (or simply Q) of about 36, and Young's Modulus (YM) of about 439K PSI.

By way of background, Q may be generally defined as a measure of the degree of damping of a resonant peak of displacement vs. frequency in the forced response of a material. Material is excited by a swept sine wave from a nearby acoustic source and displacement is measured as a function of frequency using a laser displacement measurement system. The peak resonant frequency is determined as well as the frequencies above and below the resonant peak where the response is −3 db from the peak. In other words:

Q=F resonant/(F upper−F lower).

More specifically, the standard set forth by the American Society for Testing and Materials (ASTM), designation E 756-93, entitled “Standard Test Method for Measuring Vibration-Damping Properties of Materials,” may be used to measure the damping properties of materials. Note that a material with a lower Q means it is a better damping material than a material having a higher Q. For example, a material such as wood, with a Q of about 36 is generally considered to be a good damping material. On the other hand, a material such as wood, having a YM of about 439K PSI, is not stiff enough to resist wall movement when a low frequency driver produces sound pressure within the speaker cabinet.

Moreover, design wise, there are certain limitations when manufacturing cabinets made of wood. That is, the cabinets made of wood are generally shaped like a box because shaping or bending wood adds significant cost and time to the manufacturing process. To cut manufacturing cost, speaker cabinets have been manufactured using other materials, such as thermoset and thermoplastic materials comprised of fiberglass, vinylester, or polyester resins. One of the reasons for using thermoset material is that it forms a strong material once it is molded, and since it may be moldable into three-dimensional shapes, it is also easy to manufacture. For example, a 28% glass polyester thermoset plastic material has a Q of about 77, and a YM of about 1,800K PSI. This means that the 28% glass polyester thermoset is substantially stiffer than the ½-inch MDF wood; but it does not damp as well as wood because of higher Q. Moreover, the 28% glass polyester glass is generally more expensive than wood.

Even still, a material having a YM of about 1,800 K PSI may be an overkill for a speaker cabinet design because a speaker cabinet made of a material having a YM between about 700K PSI and about 1,000K PSI is substantially resistant to wall movements due to sound pressures generated by a transducer in most frequency ranges.

Others have attempted to mold wood with some form of resin; however, such attempts have been limited to molding two-dimensional shapes, such as panels, i.e., shapes having X and Y axis but not in the vertical axis Z. One of the reasons is that, unlike in the X and Y axis, it is difficult to apply consistent pressure in the vertical axis Z when molding. Without the consistent or predictable pressure in the Z axis, the density of wood changes along the Z axis such that the composition is not consistent throughout a three-dimensional molded piece, such as a cabinet.

Therefore, there is still a need for a cabinet that is light, low cost, and easy to manufacture into three dimensional configurations; and at the same time, having a Q similar to that of wood, yet having a YM of about 700K PSI to about 1,000K PSI

### BRIEF SUMMARY OF THE INVENTION

One aspect of the present invention is to provide wood additive thermoset composite (WATC) and a method for using the WATC to mold a final product which combines the favorable qualities of both wood and thermosetting resin/plastic. That is, a WATC having a Q similar to that of wood. For example, the Q for the WATC may be less than about 55 for acceptable damping. Moreover, the WATC may have a YM to a such a degree as to substantially prevent the side walls of the speaker cabinet from deflecting to allow the transducer to act more efficiently, driving the cone rather than the side walls. As an example, to prevent such deflections in the side walls, a YM of the WATC may be at least about 700K PSI. On the other hand, a WATC having a YM much greater than about 1,000K PSI may not be necessary because the side walls may be sufficiently stiff enough here that only a nominal deflection would occur, if any. Of course, the YM of the material according to the present invention may be less than 700K PSI or more than 1,000K PSI. For example, an enclosure for a television may require a YM of about 250K, for example.

To have the Q and YM qualities as described above, a WATC according to one embodiment of the present invention includes about 46% to about 56% wood by weight with the rest being substantially thermosetting resin material. The approximate 46% to 56% wood by weight combination results in WATC that has the favorable qualities of both wood and thermoset, i.e., high damping factors, stiffness, low density and ease of molding for design flexibility. Alternatively, the WATC may include at least about 50% wood by weight and the rest being substantially thermosetting resin material by weight.

Still further, to mold the WATC into three-dimensional shape so that the composition of the WATC is substantially consistent throughout the molded piece, a predetermined amount of pressure and heat is applied to the molding process, as discussed below.

By way of background, thermoset plastic may be generally defined as a material in which cross-linking takes effect to cure. Usually a two-part composition, once it is fully cured, cannot be re-melted. One of the features of the thermoset plastic is to provide a material with high mechanical strength or stiffness. Exemplary thermoset plastics including polyester and vinylester resin in a styrene monomer form, and other materials having qualities discussed above as known to one ordinarily skilled in the art are within the scope of the present invention. Exemplary wood in accordance with the present invention may be wood flour base, which is generally a finely ground wood by-product made from maple, pine or hemp, for example. Wood flour is generally measured in “mesh” amounts of 20 mesh, 40 mesh, and 60 mesh, where the mesh size is generally determined by the number of openings in the screen, measured in the linear inch; the higher the mesh size, the smaller the particles, and the lower the number of microns, the smaller the particles. Moreover, increasing the wood content by weight of the WATC increases its damping properties, but it may reduce its mechanical properties. The complexity of the mold cavity is one of the factors that determine whether to increase or decrease the contents of the wood flour and glass in the WATC. However, to obtain the favorable qualities of both wood and thermoset, the present invention provides a WATC having about 46% to about 56% by weight of wood flour and the rest being substantially thermoset plastic.

Optionally, fillers and additives may also be added to the WATC to further enhance the manufacturing process and/or the performance of the WATC. An exemplary filler may be calcium carbonate (CaCO3), mica, talc and any combination thereof. Exemplary additives may be ionic thickeners, mold release agents to prevent parts from sticking to the mold, low profile additives to reduce shrink and enhance part smoothness, catalysts to initiate the cross-linking from liquid state to solid state cure, and dyes or pigments to mold in color.

With the present composition of WATC, a variety of products may be manufactured. For example, a speaker enclosure made of WATC would damp the high frequencies generated by the speaker and produce better quality sound. Moreover, a wood additive lowers the density of the WATC and therefore cuts down on the weight, yet remains strong. Furthermore, since the WATC is moldable, it is easy to use to manufacture a cabinet having a variety of three-dimensional configuration versus a wood cabinet that must be assembled together in the shape of a box. The cost of producing such a cabinet is also reduced as less material cost and labor are involved. Of course there are a number of other applications for the WATC, such as a television enclosure and door panels for cars, just to name a few.

In accordance with one aspect of the present invention, these and other features are accomplished by providing a WATC including at least about 50% wood by weight and the rest being substantially thermosetting resin material by weight. The above described and many other features and attendant advantages of the present invention will become apparent from a consideration of the following detailed description when considered in conjunction with the accompanying drawings.

### BRIEF DESCRIPTION OF THE DRAWINGS

A detailed description of the embodiments in accordance with the present invention will be made with reference to the accompanying drawing.

FIG. 1 is an exemplary graph illustrating Youngs Modulus versus Damping characteristics for a variety of materials.

### DETAILED DESCRIPTION OF THE INVENTION

This description is not to be taken in a limiting sense, but is made merely for the purpose of illustrating the general principles of the invention. The section titles and overall organization of the present detailed description are for the purpose of convenience only and are not intended to limit the present invention.

One aspect of the present invention is to provide a wood additive thermoset composite (WATC) and a method for molding the WATC to form a three-dimensional object such as a speaker cabinet. In particular, the WATC has approximately 48% to about 56% by weight of a wood flour additive; and approximately 44% to about 52% by weight of a thermoset plastic. Alternatively, the WATC may have at least about 50% by weight of wood and the rest being substantially a thermoset plastic by weight of the WATC. With such composition, the WATC may have a Q similar to that of wood, and a YM value of at least about 700K PSI.

One of the advantages with the above percent weight combination of the wood flour and thermoset plastic is that the WATC combines the favorable qualities of both the wood flour and thermoset plastic. For example, one of the favorable qualities of the wood is that it damps well at high frequencies. So naturally, a speaker cabinet made of wood does a good job of damping the high frequencies generated by the transducer (speaker). However, a speaker made of wood tends to be heavy versus a cabinet made of plastic, i.e., thermoset plastic, for example. Moreover, a cabinet made of wood costs more to manufacture than plastic because it generally means that the wood needs to be processed by cutting to predetermined sizes and then assembled by hand, unlike thermoset plastic that may be molded. Additionally, with the flexibility of molding plastics, new cabinet designs can be easily implemented. For example, the aerodynamic shape of a cabinet may be an important design consideration with today's loudspeaker design and, therefore, the flexibility of being able to mold to the aerodynamic shape is another advantage with plastics. However, the same is not true for wood, as cabinets made of wood generally require more hands-on work, which adds to the cost of manufacturing the cabinets. Wood, by its nature, is prepared in two dimensions requiring expensive alternative processing to achieve flexible shapes.

On the other hand, there is some downside to manufacturing a speaker cabinet with plastics as well. For example, a cabinet made of plastic resonates at high frequencies so it does not damp very well at high frequencies, as compared to wood. This is true even though a cabinet made of thermoset plastic is stiff and strong; it still does not damp very well at high frequencies. Therefore, one embodiment of the present invention is to incorporate wood flour into thermoset plastic, such that the resulting composite has the favorable qualities of both wood and thermoset plastic. In other words, a WATC that damps well at high frequencies, high stiffness, design flexibility, cost savings, reduction in weight, etc. To do so, in one embodiment of the present invention, the fiberglass content in the thermoset material is substantially, if not completely, replaced with wood flour.

By way of background, thermoset plastic material needs to be cross-linked in order to cure. The thermoset plastic is usually a two-part composition. Once the composite is fully cured, it cannot be remelted. The two compounds in the thermoset plastic may be (1) a thermosetting resin, such as polyester or vinylester resin in a styrene monomer form; and (2) a reinforcement in the form of fiberglass with some lengths of 0.05 inches to about 2.0 inches, or 15% to 66% by weight of the thermoset material, for example. Along with the thermosetting resin and the reinforcement, filler(s) and additive(s) may be added, to obtain a desired quality in the thermoset material as known to one ordinarily skilled in the art.

In one embodiment of the present invention, the fiberglass content in the above thermoset material is substantially, if not completely, replaced with wood flour. Such combination of wood and thermosetting resin provides the benefit of the damping and stiffness, among others, when cured to manufacture a cabinet. That is, the WATC gets stiffness from the thermosetting resin and damping from the wood flour. Moreover, for speaker cabinet applications, where the speaker produces high frequencies, the WATC may include approximately 48% to 56% wood flour by weight of the WATC composition, with the rest of the composition being substantially the thermosetting resin material.

One of the favorable characteristics of the thermoset plastic is its stiffness. An exemplary thermoset plastic may include polyester and vinylester resin in a styrene monomer form, and other materials having qualities discussed above as known to one ordinarily skilled in the art. An exemplary wood in accordance with the present invention may be wood flour base, which is generally a finely ground wood by-product made from maple, pine or hemp, for example. As known to one ordinarily skilled in the art, wood flour may be measured in “mesh” amounts in 20 mesh, 40 mesh and 60 mesh, where the mesh size is generally determined by the number of openings in the screen, measured in the linear inch; the higher the mesh size, the smaller the particles, and the lower the number of microns, the smaller the particles.

Moreover, increasing the wood content in the WATC improves its damping characteristics, but this would generally weaken its stiffness and lower its viscosity. Note that lowering the viscosity of the WATC means that it has greater resistance to flow and is therefore more difficult to mold. As such, in other applications where higher damping characteristics are preferred over stiffness, a WATC with greater than 56% by weight of wood, with better damping characteristics, may be utilized. That is, a WATC with greater than 56% wood by weight of the composite is within the scope of the present invention.

On the other hand, lowering the wood content in the WATC weakens its damping characteristics, but improves its stiffiness and moldability. As such, in applications where stiffness is preferred over damping characteristics, a WATC with less than 48% by weight of wood, with better stiffness characteristics, may be utilized. Therefore, a WATC with less than 48% wood by weight of the composite is within the scope of the present invention. Such applications may be for door and floor panels for a car so that outside noise may be damped so that it is quieter inside the car.

Optionally, fillers and additives may also be added to the thermosetting resin to further enhance the manufacturing process or performance of the WATC. An exemplary filler may be calcium carbonate (CaCO3), mica and talc. An exemplary additive may be ionic thickeners, mold release agents, low profile additives, catalysts and dyes or pigments to add color. Depending on the application, any one or a combination of the additives and fillers may be used, as known to one ordinarily skilled in the art. For example, ionic thickeners may be used to affect the flow of the thermosetting resin. Moreover, low profile additives may be used to reduce shrinkage of the molded product, such as a speaker cabinet, especially if there is a tight dimensional tolerance requirement. Still further, mold release agents may be used to more easily remove the product from the mold as this affects the surface finish or cosmetics of the molded product. Additionally, a catalyst may be used to speed up the cycle time; however, the catalyst may also cause more shrinkage in the product. To add color to the molded product, a dye or pigment may also be used.

That is, additives and fillers create different results when added to the composition. As known to one ordinarily skilled in the art, some additives may improve fire resistance; some improve processability in more units per time; some change the impact resistance (breakage); and some improve color. One of the reasons for using fillers is to lower the volume (quantity) of parent material and substitute it with a less expensive material. Thus, a filler of 10% mica or talc (mineral), for example, may save the overall material usage costs.

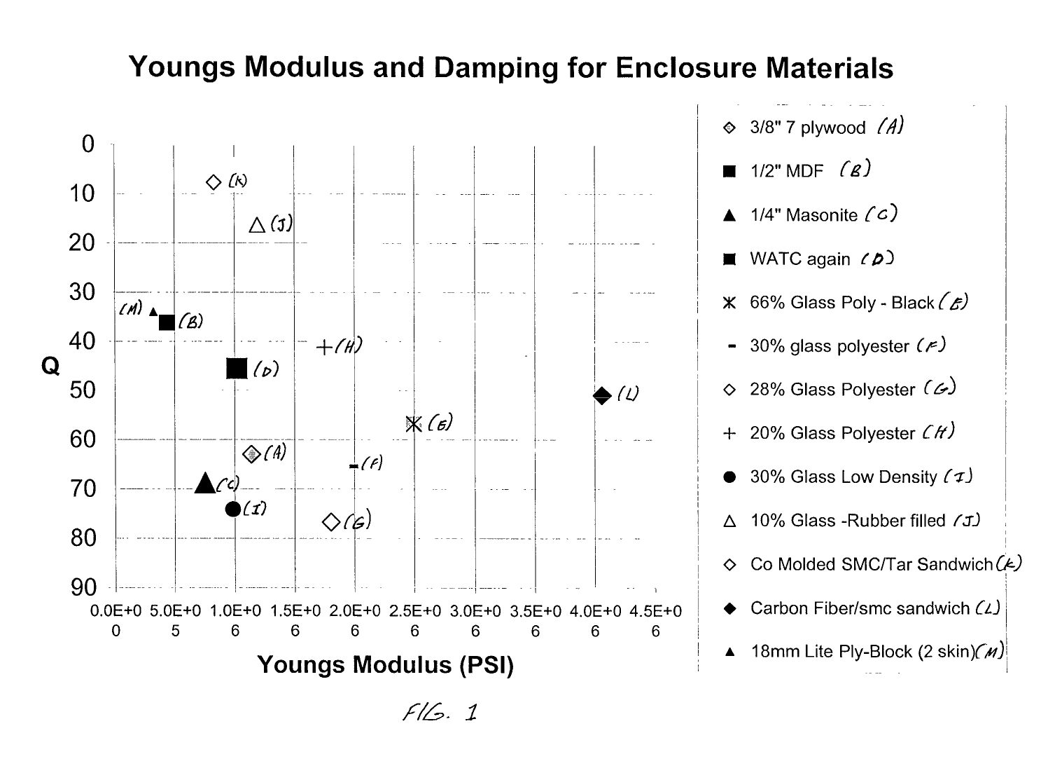

In accordance with one embodiment of the present invention, once the thermosetting resin, filler (if any) and additives (if any) are mixed together, the mixture forms a paste-like substance 20 and 20′ (see FIG. 1). The paste may be about 20,000 to about 40,000 centerpoise. As known to one ordinarily skilled in the art, centerpoise is generally a viscosity measurement of the paste. Again, depending on the application, the filler(s) may represent about 1.0% to about 10.0% by weight of the WATC. With regard to the additive(s), it may represent about 1.0% to about 5.0% by weight of the WATC. Of course, the above ranges for both the filler(s) and additive(s) added to the thermosetting resin may vary depending on the application. The paste once properly mixed may be placed in a first feeding apparatus (not shown) and a second feeding apparatus (not shown).

With the present composition of WATC, a variety of products may be manufactured. For example, a speaker enclosure made of WATC would damp the high frequencies generated by the speaker and therefore improve the quality of the sound. Moreover, wood additive lowers the density of the WATC and therefore cuts down on the weight, yet remains strong. Furthermore, since the WATC is moldable, it is easy to use to manufacture a cabinet, for example, versus a wood cabinet that must be assembled together. The cost of producing such a cabinet is also reduced as less material cost and labor is involved. Of course, there are a number of other applications for the WATC, such as a television enclosure and door panels for cars, just to name a few.

The WATC may be formulated in a variety of ways to manufacture a product. In particular, a WATC similar to the above may now be purchased in bulk sheet form in the “B” stage, i.e., in solid form, from Premix™, Inc., located at Route 20 & Harmon Road, North Kingsville, Ohio 44068, phone number (440) 224-2181 under the trade name Premi-Glas®-CWC.

Once the assembly 24 is cut into a charge, a compression molding press may be used for example to cure the charge into a product. As known to one ordinarily skilled in the art, the compression molding press generally includes a core and cavity. To mold the charge, it may be placed into the core and the cavity may be closed to begin the curing process. To cure the charge inside of the compression molding press, pressure and heat are added.

In particular, to ensure that the composition of the molded piece is substantially consistent throughout the X, Y, and Z axes, the WATC cut into a charge may be molded as in the following exemplary method. A charge in its “B” stage, may be placed into the core and the cavity, then a predetermined pressure may be applied to squeeze out the air in the charge and to shape the charge into the desired configuration, such as a cabinet. A “B” stage may be generally described as a composition of chemical binders, additives that do not crosslink until the specified temperature is reached for an activation into a liquid stage (gel time) then an “A” stage, which is the hardening stage. For example, a charge may be purchased from Premix™ with all of the elements in place in a suspended “B” stage, and then when heat is applied to the charge, the charge will first change its composition to the liquid stage, then to the second stage of hardening.

Still further, to squeeze the air out of the charge, about 1000 PSI may be applied to every 100 square inches of a charge having about 1/10-inch thickness. Such pressure also forms the charge into the desired shape. Simultaneously or in any particular order, heat may also be applied to the charge, to transition the charge from the “B” stage to an “A” stage, where the “A” stage is the solidifying stage and where the cross-linking has occurred. An exemplary temperature applied to the charge may be from about 275° F. to about 310° F.; however, the temperature applied to the charge may vary depending on the cubic volume of the charge based on a number of factors, such as the calculated gel time, size of the mold, and the distance the material had to flow.

With such temperature and pressure, back pressure is created within the mold while the charge is in the “B” stage, i.e., liquid or fluid state. That is, the high pressure being applied along the X and Y axes create a back pressure along the Z antis while the charge is in the “B” stage. This allows the density of the wood along the Z axis to be relatively consistent with the X and Y axes of the three-dimensional molded piece, thereby forming a relatively consistent composition throughout the molded piece. Moreover, the charge should stay in its “B” stage, fluid state, long enough to allow the back pressure to evenly distribute the wood within the mold. To do so, one skilled in the art may adjust the additives to regulate the gel time, i.e., to remain in the “B” stage, based on the predetermined temperature and pressure being applied to the charge. For example, for a cabinet having the following dimensions: H×W×D, the charge may be engineered with the gel time of about 90 seconds to about 120 seconds.

Incidentally, one of the advantages of using thermosetting material in the WATC is that it absorbs moisture. This allows the WATC to be subjected to heat for an extended period of time during the molding cycle without forming holes in the walls due to moisture expansion.

FIG. 1 illustrates by way of example a number of tests that were conducted using a variety of materials. Note that the alphabet letters in FIG. 1, indicating the Q and the Youngs Modulus, correspond to the list of materials to the right. For example, a cabinet molded from a WATC(D) resulted in a Q of about 46, and YM of about 1,020 PSI. Such result compared favorably with a ½-inch MDF(B) and a 18 mm Lite Ply-Block (2 skin)(M) having a YM of less than about 439K PSI, i.e., they are not stiff enough. Moreover, other materials such as 66% Glass Ploy-Black (E), ⅜-inch 7 Plywood(A), 30% Glass Polyester (F), ¼-inch Masonite(C), 30% Glass Low Density(I), and 28% Glass Polyester(G), all have a Q of at least 57, i.e., they have too high a damping factor. Still further, a Carbon Fiber/SMC sandwich(L) having a Q of about 51 and a YM of about 4,100K PSI is too expensive to use to mold a speaker cabinet. The same is true for 20% Glass Polyester(H) and Co-molded SMC/Tar Sandwich(K), i.e., they are, in comparison to WATC(D), expensive materials. With regard to 10% Glass-Rubber filled(J) this, too, is a relatively expensive material and produces poor yield due to the rubber melting and becoming sticky. Note that the above Glass materials, i.e., E, F, G, H, I, and J have the percent of glass as indicated above with rest of the composition being substantially SMC.

There are a number of advantages to the present invention. For example, being able to mold a product cuts down on the manufacturing time as well as labor. Moreover, wood flour is generally less expensive than glass fiber; therefore, there is a material cost savings as well. Yet another advantage is that wood flour generally weighs less than glass fiber so that the product made of the present invention would weigh less. Still further, a speaker cabinet made with the present invention allows for a fully moldable part that has both acoustic and strength advantages over a fabricated wood cabinet; and at the same time allows for greater design freedom.

In conclusion, it is noted that specific illustrative embodiments of the invention have been disclosed hereinabove. With respect to the claims, it is applicant's intention that the claims not be interpreted in accordance with the sixth paragraph of 35 U.S.C. §112 unless the term “means” is used followed by a functional statement.

What is claimed is:

1. A wood additive thermoset composite comprising:
at least about 50% of wood material present by weight of the composite; and
at least one thermosetting resin material present substantially accounting for the remaining weight of the composite.

2. A composite according to claim 1, wherein at least one thermosetting composite resin is polyester.

3. A composite according to claim 1, wherein at least one wood material is selected from a mesh amount of 20 mesh, 40 mesh, and 60 mesh.

4. A composite according to claim 1, wherein at least one additive material is a catalyst.

5. A composite according to claim 1, wherein at least one additive material is a dye.

6. A method for formulating a wood additive thermoset composite comprising the steps of:
laying a first layer of a thermosetting resin;
distributing wood flour onto the first layer of the thermosetting resin;
laying a second layer of the thermosetting resin over the wood flour; and
wherein the wood flour is at least about 50% by weight of the composite.

7. A method according to claim 6 further including the steps of:
squeezing the first and second layers of the thermosetting resin together.

8. A method according to claim 6 wherein the first layer of the thermosetting resin is a continuous layer.

9. A method according to claim 6 wherein the first layer of the thermosetting resin is provided by a doctor box.

10. A method of molding an apparatus using a wood additive thermoset composite (WATC) comprising the steps of:
providing a composite including thermosetting resin with a wood flour content, wherein the wood flour content is at least about 50% by weight of the composite;
placing a predetermined portion of the composite into a mold to make an apparatus;
heating the predetermined portion of the composite;
pressuring the predetermined portion of the composite; and
curing the predetermined portion of the composite within the mold to achieve resin in a catalyst cross-link state.

11. A method according to claim 10 further including the steps of:
removing the apparatus from the mold; and
de-flashing the apparatus.

12. A method according to claim 10 wherein the apparatus is a speaker cabinet.
